(19) United States
(12) Patent Application Publication
(10) Pub. No.: US 2023/0085713 A1
(43) Pub. Date: Mar. 23, 2023

(54) PLANNING SYSTEM FOR AN AUTONOMOUS WORK VEHICLE SYSTEM

(71) Applicant: CNH Industrial America LLC, New Holland, PA (US)

(72) Inventor: Brett McClelland, Chicago, IL (US)

(73) Assignee: CNH Industrial America LLC

(21) Appl. No.: 17/480,432

(22) Filed: Sep. 21, 2021

(51) Int. Cl. B60W 60/00; B60W 50/14

(52) U.S. Cl. CPC B60W 60/0025; B60W 50/14; B60W 2300/15; B60W 2555/00; B60W 2520/10; B60W 2520/12; B60W 2540/215; B60W 2555/20; B60W 2050/146

(57) ABSTRACT

A planning system for an autonomous work vehicle system includes a controller having a memory and a processor. The controller is configured to determine an action to be performed by the autonomous work vehicle system and an action location of the action in a work area, determine a transition operation associated with the action that enables the autonomous work vehicle system to perform the action at the action location, and generate a plan for operation of the autonomous work vehicle system. The plan includes the action, the action location, and the transition operation.

### BACKGROUND

The present disclosure relates generally to a planning system for an autonomous work vehicle system.

Certain autonomous work vehicle systems are controlled based on a determined path through a field. The autonomous work vehicle system may follow the path and perform certain tasks along the path, such as agricultural operations (e.g., seeding or planting, harvesting crops, etc.). The agricultural operations may be defined to begin at certain locations and/or features of the field. For example, the autonomous work vehicle system may be tasked to begin planting at a particular location in the field. In some instances, initiation of the operation may be delayed, such as due to a lead time associated with flowing seeds to soil, moving tools to a working position, etc. Accordingly, if the instructions to initiate performance of the desired operation are output in response to the autonomous work vehicle system reaching the designated location, the autonomous work vehicle system may not actually begin performing the desired operation at the designated location.

### BRIEF DESCRIPTION

Certain embodiments commensurate in scope with the disclosed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In certain embodiments, a planning system for an autonomous work vehicle system includes a controller having a memory and a processor. The controller is configured to determine an action to be performed by the autonomous work vehicle system and an action location of the action in a work area, determine a transition operation associated with the action that enables the autonomous work vehicle system to perform the action at the action location, and generate a plan for operation of the autonomous work vehicle system. The plan includes the action, the action location, and the transition operation.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an autonomous work vehicle system including an autonomous work vehicle and an agricultural implement coupled to the autonomous work vehicle;

FIG. 2 is a block diagram of an embodiment of a control system that may be employed within the autonomous work vehicle system of FIG. 1;

FIG. 3 is a schematic diagram of an embodiment of the autonomous work vehicle system of FIG. 1 within a work area;

FIG. 4 is a flow diagram of an embodiment of a process that may be employed by the control system of FIG. 2; and

FIG. 5 is a flow diagram of an embodiment of a process that may be employed by the control system of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

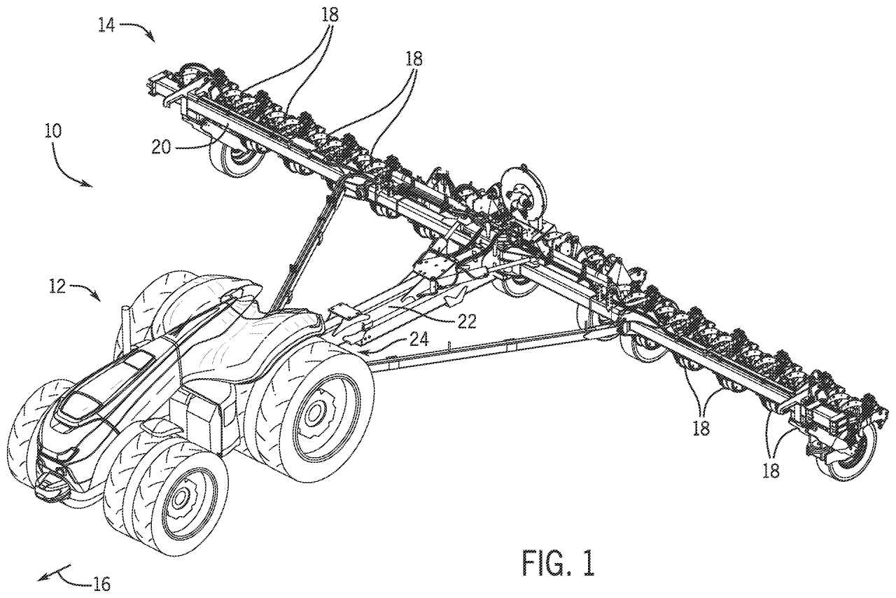

Turning now to the drawings, FIG. 1 is a perspective view of an embodiment of an autonomous work vehicle system 10 including an autonomous work vehicle 12 and an agricultural implement 14 coupled to the autonomous work vehicle 12. The autonomous work vehicle 12 includes a control system configured to automatically guide the autonomous work vehicle system 10 through a work area (e.g., along a direction of travel 16) to facilitate agricultural operations (e.g., planting operations, seeding operations, application operations, tillage operations, harvesting operations, etc.). For example, the control system may automatically guide the autonomous work vehicle system 10 through a work area (e.g., a field) without input from an operator. The control system may also automatically guide the autonomous work vehicle system 10 to perform certain actions in the work area. In some embodiments, the autonomous work vehicle may include a cab. An operator may be positioned in the cab and may view a user interface configured to display information provided by the planning system described herein, such as a plan for operating the autonomous work vehicle system.

In the illustrated embodiment, the agricultural implement 14 is a planter having multiple row units 18 distributed along a tool bar 20. Each row unit is configured to open a trench into the soil and deposit agricultural product (e.g., seed, fertilizer, etc.) into the trench, thereby establishing rows of deposited agricultural product. Certain row units may include a closing assembly to direct displaced soil into the trench and/or a packer wheel to pack soil onto the deposited agricultural product. The number of row units 18 mounted on the tool bar 20 and/or a length of the tool bar 20 may be particularly selected (e.g., based on a target row spacing, a size of the agricultural field, etc.). In the illustrated embodiment, the agricultural implement 14 includes a tow bar 22 extending between the tool bar 20 and a hitch assembly 24. The hitch assembly 24 is configured to couple the agricultural implement to a corresponding hitch assembly of the autonomous work vehicle 12. While a planter is coupled to the autonomous work vehicle 12 in the illustrated embodiment, other agricultural implements may be coupled to the autonomous work vehicle in other embodiments. For example, in certain embodiments, a seeder, an air cart, a mower, a tillage tool, a sprayer, other suitable agricultural implement(s), or a combination thereof, may be coupled to the autonomous work vehicle.

In certain embodiments, a planning system is configured to determine a plan for the autonomous work vehicle system 10 and, in some embodiments, one or more other autonomous work vehicle systems performing agricultural operations within the work area. The plan includes actions to be performed by the autonomous work vehicle system 10 in the work area (e.g., a field) and transition operations associated with the actions that enable the autonomous work vehicle system 10 to perform the actions at particular action locations. For example, the actions may include adjusting a speed of the autonomous work vehicle system 10 and/or beginning an agricultural operation at particular action location(s). To enable the autonomous work vehicle system 10 to perform the actions at the action locations, the planning system may determine the transition operations associated with the actions. In the example of adjusting the speed of the autonomous work vehicle system 10 to a target speed at a desired action location, the planning system may determine (e.g., identify) a transition operation that includes accelerating or decelerating the autonomous work vehicle system 10 at a transition location preceding the action location along the path of the autonomous work vehicle system 10, such that the autonomous work vehicle system 10 reaches the target speed at the action location. The planning system may determine the transition location based on an initial speed of the autonomous work vehicle system 10 along the path, a terrain of the work area, a work vehicle type of the autonomous work vehicle 12, an implement type of the implement 14, an expected weight of the autonomous work vehicle system 10 along the path, expected weather during operation of the autonomous work vehicle system 10, one or more user inputs, other suitable factors that may affect the speed and/or acceleration/deceleration of the autonomous work vehicle system 10, or a combination thereof. Without determining the transition operation, the autonomous work vehicle system may not reach the desired speed until some location after the action location. For example, the autonomous work vehicle system may begin accelerating or decelerating at the action point, rather than reaching the desired speed at the action point. Accordingly, the planning system described herein may enable accurate planning and control of the autonomous work vehicle system 10.

In certain embodiments, the planning system includes a control system configured to determine the plan including the actions and associated transition operations. In some embodiments, the control system may determine the plan based on inputs provided by a user (e.g., an operator, an owner, etc.) of the autonomous work vehicle system 10. For example, the planning system may include a user interface that enables the user to identify the actions and/or action locations of the work area. In certain embodiments, the control system, via the user interface, may suggest the transition operations associated with the actions and enable the user to modify and/or approve the transition operations. In some embodiments, the control system may control the autonomous work vehicle system 10 based on the generated plan. Accordingly, the control system may facilitate generating a plan for controlling the autonomous work vehicle system 10 based on desired actions and transition operations associated with the actions, thereby enabling accurate and efficient control of the autonomous work vehicle system 10 within the work area.

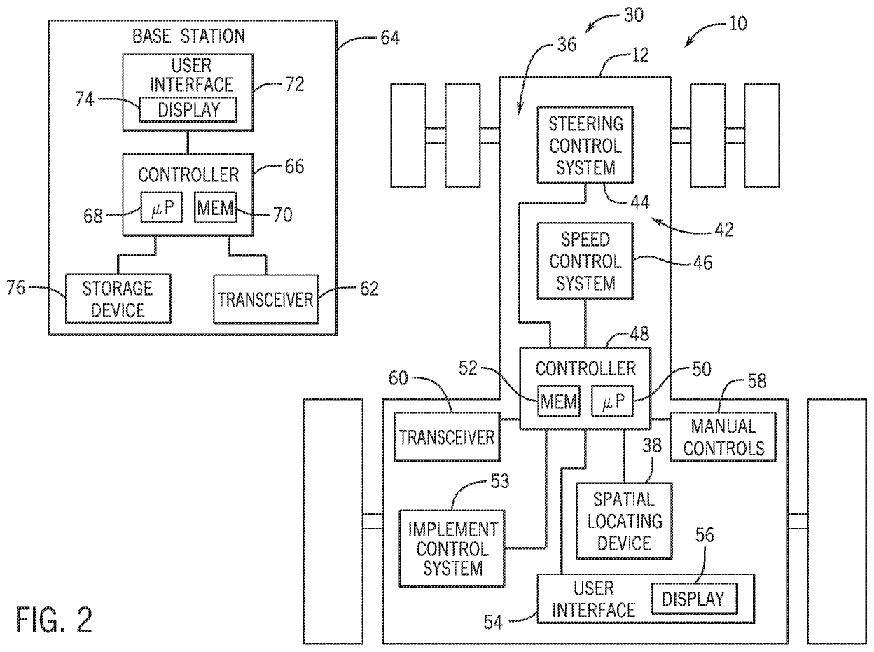

FIG. 2 is a block diagram of an embodiment of a planning system 30 including a control system 36 that may be employed within the autonomous work vehicle system 10 of FIG. 1. In the illustrated embodiment, the control system 36 includes a spatial locating device 38, which is mounted to the autonomous work vehicle 12 and configured to determine a position and, in certain embodiments, a velocity of the autonomous work vehicle 12. The spatial locating device 38 may include any suitable system configured to measure and/or determine the position of the autonomous work vehicle 12, such as a GPS receiver, for example. In some embodiments, the planning system 30 may include the autonomous work vehicle 10, the base station 64, the autonomous work vehicle system 10 generally, or a combination thereof. In certain embodiments, the spatial locating device may be mounted to the implement, such as in addition to or in place of being mounted to the autonomous work vehicle.

In the illustrated embodiment, the control system 36 includes a movement control system 42 having a steering control system 44 configured to control a direction of movement of the autonomous work vehicle 12 and a speed control system 46 configured to control a speed of the autonomous work vehicle 12. In addition, the control system 36 includes a controller 48, which is communicatively coupled to the spatial locating device 38, to the steering control system 44, and to the speed control system 46. The controller 48 is configured to automatically control the autonomous work vehicle 12 during certain phases of agricultural operations (e.g., without operator input, with limited operator input, etc.).

In certain embodiments, the controller 48 is an electronic controller having electrical circuitry configured to process data from the spatial locating device 38 and/or other components of the control system 36. In the illustrated embodiment, the controller 48 includes a processor 50, such as the illustrated microprocessor, and a memory device 52 (e.g., a memory). The controller 48 may also include one or more storage devices and/or other suitable components. The processor 50 may be used to execute software, such as software for controlling the autonomous work vehicle, software for determining a plan for the autonomous work vehicle system 10, and so forth. Moreover, the processor 50 may include multiple microprocessors, one or more “general-purpose” microprocessors, one or more special-purpose microprocessors, and/or one or more application specific integrated circuits (ASICS), or some combination thereof. For example, the processor 50 may include one or more reduced instruction set (RISC) processors.

The memory device 52 may include a volatile memory, such as random access memory (RAM), and/or a nonvolatile memory, such as read-only memory (ROM). The memory device 52 may store a variety of information and may be used for various purposes. For example, the memory device 52 may store processor-executable instructions (e.g., firmware or software) for the processor 50 to execute, such as instructions for controlling the autonomous work vehicle system 10, instructions for determining a plan for the autonomous work vehicle system 10, and so forth. In certain embodiments, the memory 52 may include one or more tangible, non-transitory, computer-readable media (e.g., machine-readable media) that store instructions executable by the processor 50 (e.g., configured to cause the processor 50 to perform certain actions) and/or data to be processed by the processor 50. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, etc.), instructions (e.g., software or firmware for controlling the autonomous work vehicle system 10, etc.), and any other suitable data.

In certain embodiments, the steering control system 44 may include a wheel angle control system, a differential braking system, a torque vectoring system, or a combination thereof. The wheel angle control system may automatically rotate one or more wheels and/or tracks of the autonomous work vehicle 12 (e.g., via hydraulic actuators) to steer the autonomous work vehicle along a target route through a work area. By way of example, the wheel angle control system may rotate front wheels/tracks, rear wheels/tracks, intermediate wheels/tracks, or a combination thereof, of the autonomous work vehicle 12 (e.g., either individually or in groups). The differential braking system may independently vary the braking force on each lateral side of the autonomous work vehicle 12 to direct the autonomous work vehicle 12 along a path. In addition, the torque vectoring system may differentially apply torque from an engine to wheel(s) and/or track(s) on each lateral side of the autonomous work vehicle 12, thereby directing the autonomous work vehicle 12 along a path. In further embodiments, the steering control system may include other and/or additional systems to facilitate directing the autonomous work vehicle 12 along a path through the work area.

In certain embodiments, the speed control system 46 may include an engine output control system, a transmission control system, a braking control system, or a combination thereof. The engine output control system may vary the output of the engine to control the speed of the autonomous work vehicle 12. For example, the engine output control system may vary a throttle setting of the engine, a fuel/air mixture of the engine, a timing of the engine, other suitable engine parameters to control engine output, or a combination thereof. In addition, the transmission control system may adjust a gear ratio of a transmission (e.g., by adjusting gear selection in a transmission with discrete gears, by controlling a continuously variable transmission (CVT), etc.) to control the speed of the autonomous work vehicle. Furthermore, the braking control system may adjust braking force, thereby controlling the speed of the autonomous work vehicle 12. In further embodiments, the speed control system may include other and/or additional systems to facilitate adjusting the speed of the autonomous work vehicle 12.

Additionally, the control system 36 includes an implement control system 53 configured to control the agricultural implement of the autonomous work vehicle system 10. The controller 48, which is communicatively coupled to the implement control system 53, is configured to automatically control the agricultural implement via the implement control system 53 during certain phases of agricultural operations (e.g., without operator input, with limited operator input, etc.). For example, the implement control system 53 may be configured to control a steering angle of the implement (e.g., via an implement steering control system having a wheel angle control system and/or a differential braking system), a speed of the autonomous work vehicle system (e.g., via an implement speed control system having a braking control system), a height of the implement (e.g., via a hitch position control system configured to control a hitch of the autonomous work vehicle and/or hitch connection(s) of the implement, via an implement wheel position control system configured to control position(s) of wheel(s) of the implement), or a combination thereof. Additionally, the implement control system 53 may be configured to control one or more tools of the implement (e.g., via a tool control system), one or more sub-frames of the implement (e.g., via a sub-frame control system), a product flow rate (e.g., via a flow rate control system), a position of the implement relative to the autonomous work vehicle 12, or a combination thereof.

In certain embodiments, the implement control system 53 is configured to instruct actuator(s) to adjust a penetration depth of at least one ground engaging tool of the agricultural implement. By way of example, the implement control system 53 may instruct actuator(s) to reduce or increase the penetration depth of each tillage point on a tilling implement, or the implement control system 53 may instruct actuator(s) to engage or disengage each opener disc/blade of a seeding/planting implement from the soil. Furthermore, the implement control system 53 may instruct actuator(s) to transition the agricultural implement between a working position and a transport position, or to adjust a position of a header of the agricultural implement (e.g., a harvester, etc.), among other operations. The autonomous work vehicle control system may also include controller(s)/control system(s) for electrohydraulic remote(s), power take-off shaft(s), adjustable hitch(es), or a combination thereof, among other controllers/control systems.

As illustrated, the autonomous work vehicle 12 includes the implement control system 53. In some embodiments, the agricultural implement may include the implement control system, such as in place of or in addition to the implement control system of the autonomous work vehicle, and/or the agricultural implement may include another control system/controller communicatively coupled to the controller of the autonomous work vehicle and/or to the implement control system of the autonomous work vehicle. For example, the autonomous work vehicle control system may be communicatively coupled to the control system/controller on the implement via a communication network, such as a controller area network (CAN bus).

In the illustrated embodiment, the control system 36 includes a user interface 54 (e.g., including a graphical user interface, a GUI) communicatively coupled to the controller 48. The user interface 54 is configured to enable an operator to control certain parameter(s) associated with operation of the autonomous work vehicle and/or the agricultural implement. For example, the user interface 54 may include a switch that enables the operator to selectively configure the autonomous work vehicle for autonomous or manual operation. In addition, the user interface 54 may include a battery cut-off switch, an engine ignition switch, a stop button, or a combination thereof, among other controls. In certain embodiments, the user interface 54 includes a display 56 configured to present information to the operator, such as a map of the work area, a visual representation of certain parameter(s) associated with operation of the autonomous work vehicle (e.g., fuel level, oil pressure, water temperature, etc.), a visual representation of certain parameter(s) associated with operation of the agricultural implement coupled to the autonomous work vehicle (e.g., seed level, penetration depth of ground engaging tools, orientation(s)/position(s) of certain components of the implement, etc.), or a combination thereof, among other information. In certain embodiments, the display 56 may include a touch screen interface that enables the operator to control certain parameters associated with operation of the autonomous work vehicle and/or the agricultural implement. For example, as described in greater detail below, the user interface 54, via the display 56, may enable the operator to identify actions to be performed and action locations for the identified actions in the work area, and/or the user interface 54, via the display 56, may enable the operator to view transition operations associated with the actions, as determined by the control system 36.

In the illustrated embodiment, the control system 36 includes manual controls 58 configured to enable an operator to control the autonomous work vehicle while automatic control is disengaged (e.g., while unloading the autonomous work vehicle from a trailer, etc.). The manual controls 58 may include manual steering control, manual transmission control, manual braking control, or a combination thereof, among other controls. In the illustrated embodiment, the manual controls 58 are communicatively coupled to the controller 48. The controller 48 is configured to disengage automatic control of the autonomous work vehicle upon receiving a signal indicative of manual control of the autonomous work vehicle. Accordingly, if an operator controls the autonomous work vehicle manually, the automatic control terminates, thereby enabling the operator to control the autonomous work vehicle.

In the illustrated embodiment, the control system 36 includes a transceiver 60 communicatively coupled to the controller 48. The transceiver 60 is configured to establish a communication link with a corresponding transceiver 62 of a base station 64, thereby facilitating communication between the base station 64 and the control system 36 of the autonomous work vehicle 12. The transceiver 60 may operate at any suitable frequency range within the electromagnetic spectrum. For example, in certain embodiments, the transceiver 60 may broadcast and receive radio waves within a frequency range of about 1 GHz to about 10 GHz. In addition, the transceiver 60 may utilize any suitable communication protocol, such as a standard protocol (e.g., Wi-Fi, Bluetooth, etc.) or a proprietary protocol. In certain embodiments, the base station 64 may be a handheld device, a laptop, or another suitable device.

In the illustrated embodiment, the base station 64 includes a controller 66 communicatively coupled to the base station transceiver 62. The controller 66 is configured to output commands and/or data to the controller 48 of the autonomous work vehicle 12. For example, the controller 66 may be configured to determine a plan and to output one or more signals indicative of the plan to the autonomous work vehicle controller 48, thereby enabling the autonomous work vehicle controller 48 to instruct the movement control system 42 to direct the autonomous work vehicle system 10 along a route of the plan.

In certain embodiments, the controller 66 is an electronic controller having electrical circuitry configured to process data from certain components of the base station 64 (e.g., the transceiver 62). In the illustrated embodiment, the controller 66 includes a processor, such as the illustrated microprocessor 68, and a memory device 70. The processor 68 may be used to execute software, such as software for determining a plan, and so forth. Moreover, the processor 68 may include multiple microprocessors, one or more “general-purpose” microprocessors, one or more special-purpose microprocessors, and/or one or more application specific integrated circuits (ASICS), or some combination thereof. For example, the processor 68 may include one or more reduced instruction set (RISC) processors. The memory device 70 may include a volatile memory, such as RAM, and/or a nonvolatile memory, such as ROM. The memory device 70 may store a variety of information and may be used for various purposes. For example, the memory device 70 may store processor-executable instructions (e.g., firmware or software) for the processor 68 to execute, such as instructions for determining a plan.

In the illustrated embodiment, the base station 64 includes a user interface 72 communicatively coupled to the controller 66. The user interface 72 is configured to present data from the autonomous work vehicle 12 and/or the agricultural implement to an operator (e.g., data associated with operation of the autonomous work vehicle 12, data associated with operation of the agricultural implement, etc.). The user interface 72 is also configured to enable an operator to control certain functions of the autonomous work vehicle system 10 (e.g., starting and stopping the autonomous work vehicle system 10, instructing the autonomous work vehicle system 10 to follow a route through the work area, identifying actions of the autonomous work vehicle system 10 and corresponding action locations, etc.). In the illustrated embodiment, the user interface 72 includes a display 74 configured to present information to the operator, such as information about the work area, actions of the autonomous work vehicle system 10, transition operations associated with actions, the position of the autonomous work vehicle system 10 within the work area, the speed of the autonomous work vehicle system 10, and the path of the autonomous work vehicle system 10, among other data.

In the illustrated embodiment, the base station 64 includes a storage device 76 communicatively coupled to the controller 66. The storage device 76 (e.g., nonvolatile storage) may include ROM, flash memory, a hard drive, or any other suitable optical, magnetic, or solid-state storage medium, or a combination thereof. The storage device(s) may store data, instructions (e.g., software or firmware for determining a plan, etc.), and any other suitable data. In some embodiments, the control system 36 may include the base station 64 or portion(s) thereof, such as the transceiver 62, the controller 66, the user interface 72, and/or the storage device 76. In certain embodiments, the control system may include other and/or additional controllers/control systems.

In certain embodiments, the controller 48 of the control system 36 of the planning system 30 is configured to determine a plan for the autonomous work vehicle system 10, including actions to be performed by the autonomous work vehicle system 10 within the work area (e.g., a field), locations of the actions (e.g., action locations), and transition operations associated with the actions that enable the autonomous work vehicle system 10 to perform the actions at the action locations. For example, prior to operation of the autonomous work vehicle system 10, the controller 48 may determine a transition operation for each action that may facilitate performance of the action at a respective action location. The transition operation may include a transition action that is performed by the autonomous work vehicle system 10 prior to the action and a transition location of the transition action. The transition operation (e.g., the transition action and the transition location) may depend on the associated action, the action location, a speed of the autonomous work vehicle system 10 (e.g., initial speed, expected speed, etc.), a terrain of the work area, a type of the autonomous work vehicle 12, a type of the implement, an expected weight of the autonomous work vehicle system along the path of the autonomous work vehicle system 10 (e.g., at the transition location, at the action location, and/or elsewhere), expected weather conditions during operation of the autonomous work vehicle system, one or more user inputs, or a combination thereof. The controller 48 may generate the plan for operating the autonomous work vehicle system 10, including a path through the work area and the actions and transition operations performed along the path. In some embodiments, the controller 48 may generate and/or modify the path based on the transition operations, the actions, the action locations, or a combination thereof. In certain embodiments, the control system 36 may display the plan via the user interface 54 to enable a user to view, approve, and/or modify the plan. For example, the user may approve and/or modify the plan as a whole, each transition operation, or portion(s) of each transition operation.

In certain embodiments, the autonomous work vehicle controller 48 determines the plan and outputs instructions to execute the plan (e.g., outputs instructions to the movement control system 42 to direct the autonomous work vehicle 12 along the path). However, in further embodiments, the plan may be determined and/or instructions to execute the plan may be output by one or more other controllers (e.g., alone or in combination with the autonomous work vehicle controller 48). For example, in certain embodiments, the control system 36 of the planning system 30 includes the base station controller 66. In such embodiments, the base station controller 66 may determine the plan and output one or more signals indicative of the plan to the work vehicle controller 48 (e.g., via the respective transceivers). The work vehicle controller 48 may then output one or more signals indicative of instructions to execute the plan (e.g., instructions to the movement control system 42 to direct the autonomous work vehicle 12 along a path of the plan). In further embodiments, the base station controller 66 may determine the plan and output one or more signals to the movement control system 42 and/or other components of the work vehicle system (e.g., via the respective transceivers, via the autonomous work vehicle controller, etc.) indicative of instructions to execute the plan (e.g., instructions to direct the work vehicle along a path of the plan, etc.). In embodiments in which the control system 36 of the planning system 30 includes the base station controller 66, the base station controller 66 may determine the plan for multiple autonomous work vehicle systems and output one or more signals indicative of the plan (e.g., including respective paths of the plan) or instructions to execute the plan to each autonomous work vehicle system (e.g., to the controller of each autonomous work vehicle system, to the movement control system of each autonomous work vehicle system, etc.).

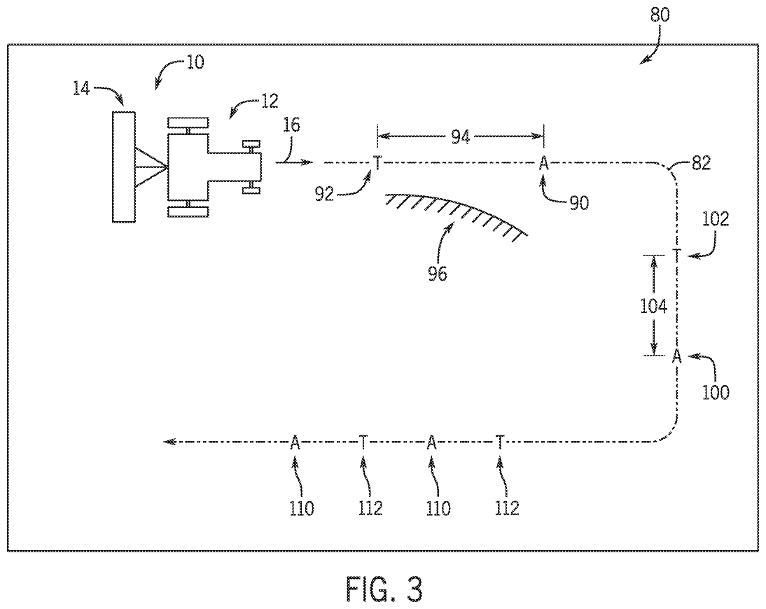

FIG. 3 is a schematic diagram of an embodiment of the autonomous work vehicle system 10 within a work area 80, in which the autonomous work vehicle system 10 is following a path 82 through the work area 80, as indicated by the direction of travel 16. The control system of the planning system (e.g., the controller of the autonomous work vehicle 12 and/or the controller of the base station) may control the autonomous work vehicle system 10 to follow the path 82 through the work area 80. As described herein, the control system is configured to determine actions to be performed by the autonomous work vehicle system 10 within the work area, such as agricultural operations, adjustments to speed, and adjustments to the direction of travel (e.g., to follow the path 82), as well as locations of the actions (e.g., action locations). Additionally, the control system is configured to determine transition operations associated with the actions that enable performance of the actions at the action locations. Each transition operation includes one or more transition actions and one or more transition locations.

In the illustrated embodiment, the control system is configured to generate the plan for operation of the autonomous work vehicle system 10, including the path 82, actions performed at action locations along the path 82, as indicated by “A” markers, and transition actions initiated at transition locations along the path 82, as indicated by “T” markers. Each transition operation is associated with a respective action. For example, the control system is configured to determine an action to be performed by the autonomous work vehicle system 10 at an action location 90 along the path 82 and a transition action associated with the action that is initiated at a transition location 92 along the path 82. In the illustrated embodiment, the action includes adjusting the speed of the autonomous work vehicle system 10 to a target speed at the action location 90. For example, the control system may determine the target speed of the autonomous work vehicle system 10 based on a user input indicating the target speed, subsequent and/or prior operations of the autonomous work vehicle system 10 (e.g., planting operations), terrain of the work area 80 at and/or adjacent to the action location 90, other suitable factor(s) that may affect operation of the autonomous work vehicle system 10, or a combination thereof.

After determining the action and the action location 90, the control system is configured to determine the transition action that is initiated at the transition location 92 preceding the action location 90 along the path 82. In the illustrated embodiment, the transition operation may include a transition action of decelerating (e.g., applying brakes, downshifting gears, etc.) or accelerating (e.g., increase engine output, upshifting gears, etc.) the autonomous work vehicle system 10, and the transition action is initiated at the transition location 92. As described herein, the control system is configured to determine the transition action of the transition operation and/or the transition location of the transition operation based on the action to be performed at the action location 90, an initial speed of the autonomous work vehicle system 10 along the path 82 (e.g., preceding the action location 90), terrain of the work area 80 (e.g., geographic features within the work area 80), soil conditions (e.g., moisture content, soil type, etc.), a type of the autonomous work vehicle 12, a type of the implement, an expected weight of the autonomous work vehicle system 10 along the path 82, expected weather conditions during operation of the autonomous work vehicle system 10, one or more user inputs, or a combination thereof. For example, if the initial speed of the autonomous work vehicle system 10 along the path 82 preceding the action location 90 exceeds the target speed to be achieved at the action location 90, the transition action of the transition operation includes initiating deceleration of the autonomous work vehicle system 10. Additionally, the control system may determine that the transition location 92 is a determined distance 94 preceding the action location 90 along the path 82, such that the determined distance 94 enables the autonomous work vehicle system 10 to decelerate to the target speed at the action location 90.

In the illustrated embodiment, the work area 80 includes a hill 96 along the path 82 preceding the action location 90. The control system is configured to determine the determined distance 94 based on a steepness (e.g., grade) of the hill 96 and the length of the hill 96, among the other factors described above. For example, the control system may determine that the determined distance 94 is greater than a determined distance within a work area that does not include a hill preceding the action location. The control system may identify the location of the hill 96 within the work area 80 and/or a steepness of the hill, may receive an indication of the location and/or the steepness of the hill 96, such as via the work vehicle user interface and/or the base station user interface, or a combination thereof.

A weight of the autonomous work vehicle system 10 may affect deceleration/acceleration of the autonomous work vehicle system 10. Accordingly, the control system may determine the transition operation based on the weight. For example, the autonomous work vehicle system may include a harvester that collects crops, such that the weight of the autonomous work vehicle system is variable (e.g., generally increases) as the autonomous work vehicle system moves along the path. The control system may consider an expected weight of the autonomous work vehicle system along the path and/or a rate at which the weight is expected to increase to determine the transition operation.

In certain embodiments, the control system is configured to determine an action to be performed by the autonomous work vehicle system 10 at an action location 100 along the path 82 and a transition operation associated with the action including a transition action that is initiated at a transition location 102 along the path 82. The action to be performed at the action location 100 includes an agricultural operation of planting seeds, which is to be performed by the implement 14. In other examples, the action may include tilling, fertilizing soil, harvesting crops, or a combination thereof. The control system may determine the action and/or a position of the action location 100 based on a user input, location of crops within the field, location of field boundaries, or a combination thereof, among other factors.

After determining the action and the action location 100, the control system is configured to determine the transition action that is initiated at the transition location 102 preceding the action location 100 along the path 82. In the illustrated embodiment, the transition operation may include a transition action of initiating seed flow from seed storage container(s) of the implement 14 at the transition location 102, such that the implement 14 begins depositing seeds into the soil at the action location 100. The control system is configured to determine the transition action of the transition operation and/or the transition location of the transition operation based on the action to be performed at the action location 100, a desired seed spacing, a size/type/configuration of the implement 14, an expected speed of the autonomous work vehicle system 10 along the path 82 (e.g., preceding the action location 100 along the path 82), one or more user inputs, or a combination thereof. For example, the control system may determine that the transition action includes initiating seed flow from the seed storage container(s) at a target rate that achieves the desired seed spacing starting at the action location 100. Additionally, the control system may determine that the transition location 102 is a determined distance 104 preceding the action location 100 along the path 82, such that the determined distance 104 enables the autonomous work vehicle system 10 to begin depositing seeds at the action location 100. For example, the type and size of the implement 14 may indicate that seeds take a particular amount of time to reach the soil from the seed storage container(s) (e.g., based on distance(s) between the seed storage container(s) and the soil along seed flow path(s)). Based on the amount of time and the expected speed of the autonomous work vehicle system 10 along the path 82, the control system is configured to determine the position of the transition location 102.

In certain embodiments, the transition operation may include multiple transition actions and/or multiple transition locations. For example, the control system may determine that, to perform the action at the action location, multiple transition actions may be performed prior to the action, such as in sequence and/or in parallel. In the example above of the action performed at the action location 100, the control system may determine that the transition operation includes adjusting a position and/or a configuration of the implement 14, such as in addition to initiating the flow of seeds. The control system may determine that the implement 14 is not in an appropriate configuration for depositing seeds (e.g., the implement 14 may be in a transport configuration, a headland turn configuration, or otherwise not in a planting configuration) prior to reaching the action location 100 along the path 82. Accordingly, the transition operation may include adjusting the configuration of the implement 14 at the transition location 102. In some embodiments, the transition operation may include multiple transition locations. For example, the control system may determine that the implement may begin flowing seeds from the seed storage container(s) at the transition location 102 and that initiation of the adjustment to the configuration of the implement 14 may begin at another location between the transition location 102 and the action location 100 to enable the implement 14 to begin depositing seeds in the soil at the action location 100.

In certain embodiments, the control system is configured to determine additional and/or other actions to be performed in the work area 80, action locations, and transition operations associated with the actions. In the illustrated embodiment, the control system is configured to determine actions to be performed at action locations 110, positions of the action locations 110, and transition actions associated with the actions that are initiated at transition locations 112. Examples of the actions that may be initiated at the action locations 110 include adjusting the implement 14 to a non-working configuration (e.g., a configuration in which the implement 14 is unable to deposit seeds into soil), adjusting a seed flow rate, adjusting how many rows of seeds are planted, changing a penetration depth of seeding tools, changing a type of agricultural product being deposited, or a combination thereof.

In other embodiments of the autonomous work vehicle system, such as those including a tillage implement and/or a harvester, the control system may determine other actions to be performed at the action locations, such as certain agricultural operations (e.g., a tilling operation, a harvesting operation) and/or other suitable actions to be performed by the autonomous work vehicle system. For example, the tilling operation may include changing a penetration depth of tillage tools, changing angles (e.g., aggressiveness) of tillage tools, or a combination thereof. The harvesting operation may include changing a harvester header angle, changing a harvester head position, or a combination thereof.

For each of these additional or alternative actions, the control system is configured to determine a transition operation associated with the respective action including a transition action that is initiated at a respective transition location. The transition operation facilitates and enables performance of the respective action at the respective action location. The control system is configured to determine each transition operation based on the respective action to be performed at the action location, an expected speed of the autonomous work vehicle system along the path (e.g., preceding the action location), terrain of the work area, soil conditions, a type of the autonomous work vehicle, a size/type/configuration of the implement, whether the implement is in a working configuration or a non-working configuration, an expected weight of the autonomous work vehicle system along the path, expected weather conditions during operation of the autonomous work vehicle system, one or more user inputs, or a combination thereof.

After determining the actions, action locations, and transition operations associated with the actions, the control system is configured to generate a plan for operation of the autonomous work vehicle system 10. The plan may include the path 82, the actions performed at the action locations 90, 100, and/or 110, the transition actions initiated at the transition locations 92, 102, and/or 112, or a combination thereof. In certain embodiments, the control system is configured to determine and/or optimize the path 82, such that the path 82 intersects each action location and each transition location and does not unnecessarily travel to or through other portions of the work area 80.

As described above, the control system is configured to control the autonomous work vehicle system 10 based on the generated plan and/or to output instructions to execute the plan. In certain embodiments, after initially generating the plan, the control system is configured to update the plan based on new and/or updated information. For example, prior to, during, and/or after operation of the autonomous work vehicle system 10 within the work area 80, the control system is configured to update the path 82, the actions to be performed at the action locations, the transition actions to be initiated at the transition locations, or a combination thereof. The new and/or updated information may include an updated weight of the autonomous work vehicle system 10, an updated speed of the autonomous work vehicle system 10, updated information regarding the terrain and/or soil conditions of the work area 80, updated weather conditions, a state (e.g., configuration) of the autonomous work vehicle 12, a state (e.g., configuration) of the implement 14, one or more user inputs, or a combination thereof. After updating the plan, the control system is configured to control the autonomous work vehicle system 10 based on the updated plan.

For example, during operation of the autonomous work vehicle system 10 along the path 82, the weight of the autonomous work vehicle system 10 may be different from an expected weight of the autonomous work vehicle system 10 (e.g., the expected weight determined prior to operation), which may affect a speed of the autonomous work vehicle system 10 and/or an ability of the autonomous work vehicle system 10 to accelerate/decelerate. In certain embodiments, the different weight may be due to a different amount of agricultural product within the autonomous work vehicle system, such as in a storage compartment of the implement. Accordingly, the control system is configured to update the transition operation associated with the action to be performed at the action location based on the updated weight. For example, an increase in the weight may increase a distance sufficient to slow the autonomous work vehicle system 10 to the target speed. Accordingly, the control system may determine a new transition location 92 that is farther from the action location 90 (e.g., the determined distance 94 may increase).

In another example, during operation of the autonomous work vehicle system 10 along the path 82, the weather conditions may be different from expected weather conditions determined prior to operation of the autonomous work vehicle system 10. For example, the expected weather conditions may include clear skies, while the actual weather conditions during operation may include rain. The rain may change soil conditions in certain portions of the work area 80, such as by causing the portions to become muddy. The control system may adjust the path 82 through the work area 80 to avoid such portions of the work area 80. In certain embodiments, the control system may adjust certain transition operations based on the updated weather conditions, such as by adjusting certain transition actions, adjusting positions of certain transition locations, and/or omitting certain transition operations.

In certain embodiments, the control system of the planning system may present information regarding the plan for operation of the autonomous work vehicle system 10 via a user interface (e.g., the user interface of the autonomous work vehicle 12 and/or the user interface of the base station). In addition, the control system may enable a user to adjust (e.g., modify) and/or approve the plan via the user interface. For example, the user interface may present a map of the work area 80. The map may include indications of the path 82, the action locations, actions to be performed at the action locations, transition locations, transition actions initiated at the transition locations, the determined distances between action locations and transition locations, or a combination thereof. In some embodiments, the map may indicate certain geographic features, such as the hill 96.

In certain embodiments, the user may provide inputs to the user interface indicative of the actions and/or the action locations. The user interface may include a display having a touch-screen interface, and the user may identify a particular location within the work area 80 to perform an action via input to the touch-screen interface. For example, the user may provide an indication to perform an action including a planting operation at the action location 100. In response to receiving the user input, the control system is configured to determine the transition operation associated with the action (e.g., the transition location 102 and the transition action initiated at the transition location 102). The control system may present, via the user interface, an indication of the transition operation including the transition location 102 and/or the transition action (e.g., via a text window identifying the transition action). The user may view the indication of the transition operation and adjust and/or approve the transition operation. In response to receiving user approval, the control system may generate the plan for operation of the autonomous work vehicle system 10. In some embodiments, the control system may proceed to generate the plan without user approval and/or may display the plan for viewing by the user, but may not enable the user to modify or approve the plan.

In response to receiving a user adjustment of one or more actions, one or more action locations, one or more transition operations, or a combination thereof, the control system is configured to update the plan for operation of the autonomous work vehicle system. For example, the control system may initially determine that the transition operation associated with the action location 100 includes a transition location 102 at the position illustrated in FIG. 3. The user may provide an input to move the transition location farther from the action location 100. In response, the control system is configured to update the plan to cause the autonomous work vehicle system 10 to initiate the transition operation at the new, updated position of the transition location 102.

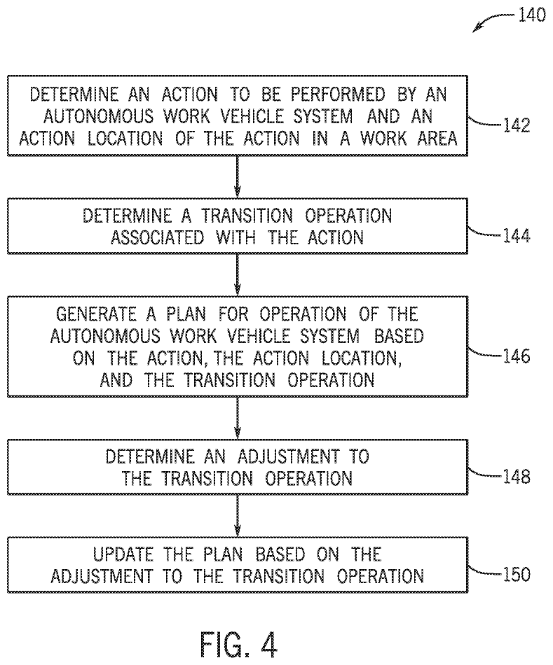

FIG. 4 is a flow diagram of an embodiment of a process 140 for generating a plan for controlling the autonomous work vehicle system. For example, the process 140, or portions thereof, may be performed by the control system described above (e.g., the controller of the autonomous work vehicle and/or the controller of the base station). Although the following description of the process 140 is described as including certain steps performed in a particular order, it should be understood that the steps of the process 140 may be performed in any suitable order, that certain step(s) may be omitted, and/or that certain step(s) may be added.

The process 140 begins at block 142, in which the control system determines an action to be performed by an autonomous work vehicle system and an action location of the action in a work area. For example, the control system may determine the action and/or the action location based on a user input indicating the action and/or the action location, subsequent and/or prior operations of the autonomous work vehicle system, terrain of the work area at and/or adjacent to the action location, other suitable factor(s) that may affect operation of the autonomous work vehicle system, or a combination thereof.

At block 144, the control system determines a transition operation associated with the action. The transition operation may include a transition action that is performed by the autonomous work vehicle system preceding the action along a path through the work area and a transition location of the transition action. The control system may determine the transition operation (e.g., the transition action and the transition location) based on the associated action, the action location, a speed of the autonomous work vehicle system (e.g., initial speed, expected speed, etc.), a terrain of the work area, a type/configuration/size of the autonomous work vehicle, a type/configuration/size of the implement, an expected weight of the autonomous work vehicle system along the path (e.g., at the transition location, at the action location, and/or elsewhere), expected weather conditions during operation of the autonomous work vehicle system, one or more user inputs, other suitable factor(s) that may affect operation of the autonomous work vehicle system, or a combination thereof.

At block 146, the control system generates a plan for operation of the autonomous work vehicle system based on the action, the action location, and the transition operation. In certain embodiments, the plan includes the path through the work area. In some embodiments, the control system may control the autonomous work vehicle system based on the plan and/or may output instructions to control the autonomous work vehicle system based on the plan.

At block 148, the control system determines an adjustment to the transition operation. For example, the control system may determine the adjustment based on new and/or updated information regarding the autonomous work vehicle system (e.g., weight, speed, configuration, etc.), the work area (e.g., terrain, soil conditions, etc.), weather conditions, one or more user inputs, other suitable factor(s) that may affect operation of the autonomous work vehicle system, or a combination thereof.

At block 150, the control system updates the plan based on the adjustment to the transition operation. The updated plan may include the updated transition operation, the associated action, and the action location. In certain embodiments, the updated plan may include the path of the autonomous work vehicle system through the work area.

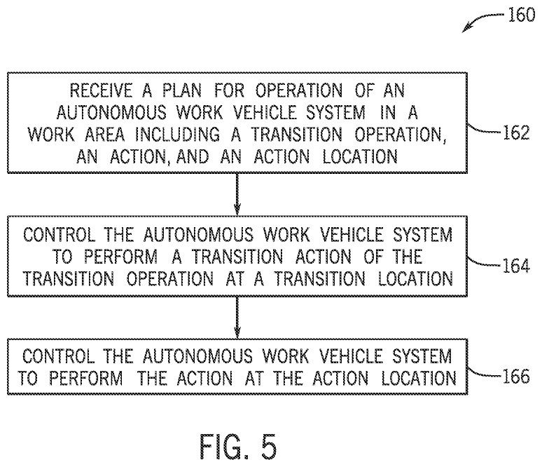

FIG. 5 is a flow diagram of an embodiment of a process 160 for executing a plan for controlling the autonomous work vehicle system. For example, the process 160, or portions thereof, may be performed by the control system described above (e.g., the controller of the autonomous work vehicle and/or the controller of the base station). Although the following description of the process 160 is described as including certain steps performed in a particular order, it should be understood that the steps of the process 160 may be performed in any suitable order, that certain step(s) may be omitted, and/or that certain step(s) may be added.

The process 160 begins at block 162, in which the control system receives a plan for operation of an autonomous work vehicle system within a work area. The plan includes action(s) to be performed by the autonomous work vehicle system, action location(s) of the action(s), and transition operation(s) associated with the action(s) that enable performance of the action(s) at the action location(s). In certain embodiments, the plan may be generated by the control system, such as via the process described in reference to FIG. 4. In some embodiments, a controller of the control system (e.g., the controller of the autonomous work vehicle or the controller of the base station) may generate the plan and output the plan to another controller of the control system (e.g., the other of the controller of the autonomous work vehicle or the controller of the base station). The other controller may receive and execute the plan.

At block 164, the control system controls the autonomous work vehicle system to perform a transition action of a transition operation at a transition location of the transition operation. The transition operation may be associated with an action to be performed at an action location. The transition location may generally precede the action location along the path of the autonomous work vehicle system, such that the transition action enables performance of the action at the action location.

At block 166, the control system controls the autonomous work vehicle system to perform the action at the action location in the work area. After performing the action, the control system may control the autonomous work vehicle system to perform a next transition action and/or next action along the path through the work area and/or may control the autonomous work vehicle system to follow the path toward the next transition operation and/or the next action.

Accordingly, the control system of the planning system described herein facilitates generation of a plan for controlling the autonomous work vehicle system. For example, the control system may automatically determine actions to be performed by the autonomous work vehicle system, action locations, and transition operations associated with the actions. The transition operations may enable and facilitate performance of the actions at the action locations. The control system may generate the plan for controlling the autonomous work vehicle system based on the actions, action locations, and transition operations. Additionally, the control system may include a user interface, enabling a user to view, adjust, and/or approve the plan or portion(s) thereof (e.g., the actions, the action locations, and the transition operations). Further, the control system may update the plan based on new and/or updated information regarding the autonomous work vehicle system and control the autonomous work vehicle system based on the generated or updated plan. As such, the control system may determine transition operations that enable actions to be performed at action locations (e.g., as compared to an action that would otherwise be initiated at the action location and that would not actually begin until a location past the action location), such that the control system facilitates control and use of the autonomous work vehicle system.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A planning system for an autonomous work vehicle system, comprising:
a controller comprising a memory and a processor, wherein the controller is configured to:
determine an action to be performed by the autonomous work vehicle system and an action location of the action in a work area;
determine a transition operation associated with the action that enables the autonomous work vehicle system to perform the action at the action location; and
generate a plan for operation of the autonomous work vehicle system, wherein the plan comprises the action, the action location, and the transition operation.

2. The planning system of claim 1, wherein the transition operation comprises a transition action and a transition location, wherein the transition action is configured to be initiated at the transition location to enable the autonomous work vehicle system to perform the action at the action location.

3. The planning system of claim 2, wherein the transition location is a determined distance preceding the action location along a path of the autonomous work vehicle system.

4. The planning system of claim 1, wherein the controller is configured to determine the transition operation based on the action, the action location, a speed of the autonomous work vehicle system, a terrain of the work area, a work vehicle type of a work vehicle of the autonomous work vehicle system, an implement type of an implement of the autonomous work vehicle system, one or more expected weights of the autonomous work vehicle system, expected weather conditions during operation of the autonomous work vehicle system, one or more user inputs, or a combination thereof.

5. The planning system of claim 1, wherein the controller is configured to:
determine an adjustment to the transition operation based on a weight of the autonomous work vehicle system, a speed of the autonomous work vehicle system, terrain of the work area, weather conditions, a work vehicle state, an implement state, one or more user inputs, or a combination thereof; and
update the plan for operation of the autonomous work vehicle system based on the adjustment.

6. The planning system of claim 1, wherein the controller is configured to:
determine an additional action to be performed by the autonomous work vehicle system and an additional action location of the additional action in the work area, wherein the additional action is different than the action;
determine an additional transition operation associated with the additional action that enables the autonomous work vehicle system to perform the additional action at the additional action location; and
update the plan for operation of the autonomous work vehicle system to include the additional action, the additional action location, and the additional transition operation.

7. The planning system of claim 1, wherein the controller is configured to instruct a user interface to display a map of the work area, and the controller is configured to instruct the user interface to display indications of the action, the action location, and the transition operation on the map.

8. The planning system of claim 7, wherein the controller is configured to:
receive, via the user interface, a user input indicative of an adjustment to the transition operation; and
update the plan for operation of the autonomous work vehicle system based on the adjustment.

9. The planning system of claim 7, wherein the controller is configured to:
receive, via the user interface, a user input indicative of approval of the transition operation; and
in response to receiving the user input indicative of approval, generate the plan for operation of the autonomous work vehicle system.

10. The planning system of claim 1, wherein the controller is configured to control operation of the autonomous work vehicle system based on the plan.

11. A method of planning operation of an autonomous work vehicle system, comprising:
determining an action to be performed by the autonomous work vehicle system and an action location of the action in a work area;
determining a transition operation associated with the action that enables the autonomous work vehicle system to perform the action at the action location; and
generating a plan for operation of the autonomous work vehicle system, wherein the plan comprises the action, the action location, and the transition operation.

12. The method of claim 11, comprising:
determining an adjustment to the transition operation based on a weight of the autonomous work vehicle system, a speed of the autonomous work vehicle system, terrain of the work area, weather conditions, a work vehicle state, an implement state, one or more user inputs, or a combination thereof; and
updating the plan for operation of the autonomous work vehicle system based on the adjustment.

13. The method of claim 11, wherein the transition operation comprises a transition action and a transition location, wherein the transition action is configured to be initiated at the transition location to enable the autonomous work vehicle system to perform the action at the action location.

14. The method of claim 11, comprising determining the transition operation based on the action, the action location, a speed of the autonomous work vehicle system, a terrain of the work area, a work vehicle type of a work vehicle of the autonomous work vehicle system, an implement type of an implement of the autonomous work vehicle system, one or more expected weights of the autonomous work vehicle system, expected weather conditions during operation of the autonomous work vehicle system, one or more user inputs, or a combination thereof.

15. The method of claim 11, comprising controlling operation of the autonomous work vehicle system based on the plan.

16. One or more tangible, non-transitory, machine-readable media comprising instructions configured to cause a processor to:
determine an action to be performed by an autonomous work vehicle system and an action location of the action in a work area;
determine a transition operation associated with the action that enables the autonomous work vehicle system to perform the action at the action location; and
generate a plan for operation of the autonomous work vehicle system, wherein the plan comprises the action, the action location, and the transition operation.

17. The one or more tangible, non-transitory, machine-readable media of claim 16, wherein the instructions are configured to cause the processor to:
determine an adjustment to the transition operation based on a weight of the autonomous work vehicle system, a speed of the autonomous work vehicle system, terrain of the work area, weather conditions, a work vehicle state, an implement state, one or more user inputs, or a combination thereof and update the plan for operation of the autonomous work vehicle system based on the adjustment.

18. The one or more tangible, non-transitory, machine-readable media of claim 16, wherein the instructions are configured to cause the processor to control operation of the autonomous work vehicle system based on the plan.

19. The one or more tangible, non-transitory, machine-readable media of claim 16, wherein the instructions are configured to cause the processor to instruct a user interface to display a map of the work area, and the instructions are configured to cause the processor to instruct the user interface to display indications of the action, the action location, and the transition operation on the map.

20. The one or more tangible, non-transitory, machine-readable media of claim 19, wherein the instructions are configured to cause the processor to:
receive, via the user interface, a user input indicative of approval of the transition operation; and
in response to receiving the user input indicative of approval, generate the plan for operation of the autonomous work vehicle system.
